(19) United States
(12) Patent Application Publication
(10) Pub. No.: US 2022/0265494 A1
(43) Pub. Date: Aug. 25, 2022

(54) Extension of Patient Support Deck

(71) Applicant: Linet spol s.r.o., Slany (CZ)

(72) Inventors: Michal Sommer, Praha 6 - Brevnov (CZ); Jan Ruprich, Berovice (CZ)

(73) Assignee: Linet spol s.r.o., Slany (CZ)

(21) Appl. No.: 17/636,847

(22) PCT Filed: Aug. 19, 2020
(86) PCT No.: PCT/CZ2020/000037

§ 371 Date: Feb. 18, 2022

(30) Foreign Application Priority Data
Aug. 20, 2019 (CZ) PV 2019-546

(51) Int. Cl. A61G 7/002

(52) U.S. Cl. CPC A61G 7/002; A61G 2200/18

(57) ABSTRACT

A patient support apparatus comprises a deck extension assembly having a handle or more handles located on the support frame. The deck extension part is configured to extend and retract relative to the support frame by pulling the handle easily by one hand and with exerting minimum force that is necessary to extend the patient support deck.

### TECHNICAL FIELD OF THE INVENTION

A patient support apparatus comprises a deck extension assembly having a handle or more handles located on the support frame. The deck extension part is configured to extend and retract relative to the support frame by pulling the handle easily by one hand and with exerting minimum force that is necessary to extend the patient support deck.

### BACKGROUND OF THE INVENTION

Different types of patient support apparatuses are supplied to hospitals, health care and nursing care facilities or settings. Conventional patient support apparatuses used in health care facilities comprise a patient support deck with side rails carried by a support frame coupled to four legs. The patient support deck has several articulating sections, such as back section, leg section or foot section that may be positioned into different angles or comfort positions manually or electrically. This type of patient support apparatuses often has no base with castors to transport the patient support apparatus from place A to place B therefore complies to be used particularly in nursing care facilities.

Other more sophisticated patient support apparatuses comprise a base, a lower support frame, a positionable patient support deck with side rails carried by the upper support frame. Said patient support apparatuses comprise a base equipped with four casters for easy transport of the patient support apparatus from place A to place B, in some embodiments the base may be equipped also with the fifth castor, whereas at least one of the castors is guiding or powered. The lower support frame and the upper support frame are coupled using different types of lifting or positioning equipment, such as scissor lifting equipment, several telescopic columns of different types in amount according to number of positions into which the patient support apparatus may be positioned (e.g. in case of lateral tilting it is necessary to have three telescopic columns, in case of positioning the patient support apparatus from the lowest to the highest position scissor lifting element or two telescopic columns are used).

Regardless the patient support apparatus type or type of care facility all patient supports apparatuses have one feature in common and this is dimensions of the patient support deck. On regular basis, health and care facilities use patient support apparatuses with standard length of 200 cm, for children care facilities are used patient support apparatuses complying with child age and having length of 150 cm or 175 cm or 180 cm. However, not all care facilities or states follow the same criteria and standards for the length of the patient support apparatus and therefore it is preferable to have a possibility to extend the patient support deck by needed length. It should also be noted that standards for length of patient support apparatuses may differ in the individual states. In principle, standards differ in the individual states according to average height of inhabitants. As the manufacturers of patient support apparatuses try to cover as large world market as possible, patient support apparatuses with extendible length may cover larger market with lower production costs. Customers in countries with different standard for the length of the patient support apparatus may profit from possibility to extend the patient support deck according to applicable standards, needs of the subjected care facility or a height of a patient.

Persons taller by 10, 15, 20 or 30 cm etc. than applicable standards for adults or children are, have problem with allocation into care facilities as lying on standard dimension patient support apparatuses may not be comfortable. Should any care facility not have any above standard patient support apparatus, standard patient support apparatuses need to be used with footboard removed off. Such solution is not comfortable for a patient as patient legs lay over the patient support deck and are in free space which is even not safe. In case of a child patient standard patient support apparatus may be borrowed from any adult care facility department, however thus decreasing the overall capacity of adult patients in said care facility.

With respect to the aforesaid needs it is desired and advisable to offer patient support apparatuses with deck extension assembly. One example of known type of deck extension mechanism is for example foot end latch mechanism described in the patent U.S. Pat. No. 6,968,584 B1. This patent describes extension of the support deck by means of two frame elements of the cross beam which are movably coupled by latch mechanism comprising an arm pivotally coupled to one frame element and the said pivot serves for rotating between a locked status and an opened or engaged status. The said arm comprises a part which is inserted into the balancing holes if in locked status and is retracted from the balancing holes to disconnect the frame elements and remove them in the engaged status.

This mechanism describes extension of the deck support, however, it may be used only in case there is no patient or a mattress on the patient support apparatus. The support deck needs to be retracted after release of protrusions and consequently the support deck needs to be secured after retracting by means of pivot which is inserted into the appropriate hole in the frame element. In addition, this action needs to be done on all securing parts of the given extension. The system is thus not comfortable, is slow and time-consuming. At least two persons are necessary to provide such extension of the support deck.

Another technical solution for extension of the patient support deck is patent U.S. Pat. No. 6,968,584 B1, which deals with extension of the support deck only in the foot section by means of two horizontal positioned telescopic rails with gearing which moves inside the foot section of the patient support apparatus. The rails move only between two positions which are the retracted shortest position and extracted longest position. Both positions are secured by means of two spring arrest latch mechanisms, which are located vertical relative to rails under the foot section. The spring arrest latch mechanisms are interconnected with Bowden cable having a handle. When pressing the handle, the Bowden cable locks off the arrest latch and a caregiver can release the rail position of the extension of the patient support deck as required, i.e. extend the patient support deck or retract the patient support deck into the initial position. This spring arrest latch mechanism with Bowden cable is not comfortable. First, it is necessary to lock off both latches in parallel therefore a caregiver must use both hands and exert substantial force to overcome the resistance which is developed on the spring of the arrest mechanism. Another disadvantage is that the Bowden cable hangs free under the patient support apparatus when the support deck is in the retracted position therefore the cable may be worn or damaged fast, mechanism is predisposed to be often defective due to catching or tearing of the Bowden cable and in addition, the entire mechanism is difficult to be cleaned. Another defect may be caused by stripped rack when often used. This system is effective yet hard for operation, technically complicated and expensive for production. The financial aspect is inconvenient also from the long term point of view as the system is faulty and needs to be serviced often. Due to bad ability to be cleaned as stated above this system is not convenient to be used in health care and nursing care facilities or settings for hygienic reasons.

In the present state of the art lot of electrically driven mechanisms for extension of patient support deck are known which enable to extend and retract the patient support deck unattended. These mechanisms are usually controlled on controllers, side rails, or handrails in the headboard section of the patient support. The mechanisms are sophisticated, however very complex, demanding for production, and expensive, and the change of patient support deck length is slow. In addition, in case of outage it is not possible to extend the patient support deck or return it to the original position.

To overcome one or more the aforesaid challenges it is desired to have patient support apparatus with practical and simple mechanism for extension of the patient support deck. Such mechanism shall be simple in construction, easily operable with one hand to deprive a caregiver of exerting large force to extend the patient support deck, safe, and in the preferred embodiment also cheap for production. Our preferred embodiment is also failure free as minimum components secure minimum failure rate and service is not needed too often. Said preferred embodiment complies with high hygienic criteria in health care and nursing care facilities or settings because it is located and designed to avoid any leaking in.

### SUMMARY OF THE INVENTION

Aforesaid challenges and disadvantages are overcome by below described technical solution for hospital patient supports, nursery patient support, stretchers etc. used in health care and nursing care facilities or settings. The presented embodiment describes extension assembly of a patient support deck and comprises at least one handle located under the bearing crossbar of the patient support deck which controls extendable section of the patient support deck frame. The assembly continues two bearing elements of the patient support deck frame and is telescopically coupled with the patient support deck frame and moves sliding in the horizontal position between the retracted position and different lengths of extended positions.

The presented preferred embodiment comprises an extension part of the frame and at least one connecting member that comprises of a profile guide (a tube), which is adapted on its first end to be coupled to the upper frame of the patient support deck. The connecting member moves telescopically in the horizontal position and is controlled on its second end by a handle, or a handrail. In the retracted position the telescopically moving connecting member is retracted into the profile guide of the upper frame of the patient support deck at least half-length and in the extended position the telescopically moving connecting member is extended from the profile guide of the upper frame of the patient support deck at least half-length. The telescopically moving connecting member has a sliding runner on at least one end of the connecting member to move easily from retracted or extended position, the said connecting member is hollow and the hollow part is equipped with locking or stopping mechanism to release and lock the telescopic function of the connecting member. The said telescopically moving connecting member is a part of extension assembly of the patient support deck and is controlled by at least one handle located under the bearing crossbar of the patient support deck. The said telescopically moving connecting member is fixed coupled to the bearing crossbar of the footboard on the other end so that the handle handling the entire extension assembly could hang loose on the internal locking mechanism of this connecting member. The internal locking mechanism of said connecting member comprises a rocker arm having a latch at least on one end of the rocker arm that latches to at least one retaining hole of the latch. The retaining hole is at least one on the upper frame of the patient support deck, preferably one retaining hole is also on the telescopically moving connecting member. The rocker arm has one pivot point comprising of a protrusion on the rocker arm bar or optionally of a pivot. The rocker arm has an actuating member shaped as a letter “S” (hereinafter as S-member) hinged on the other end of the rocker arm. This S-member is terminated on its opposite end by a handle located under the bearing crossbar of the patient support footboard. In the preferred embodiment the S-member transmits motion of the handle on the rocker arm that moves up after transmitting the force from the S-member and with the help of pivot of the rocker arm, the rocker arm with the latch on the opposite end overbalances by which the latch raises up and the telescopically moving connecting member locks off from the retained position to the released position which enables the telescopically moving connecting member to move free in the upper frame of the patient support deck. Reversely, by releasing the handle the latch falls down into the retaining hole of the latch in the upper frame of the patient support deck and thus a given position is secured depending on which direction the telescopically moving connecting member was moving, or which direction the extension assembly was moving using the handle. If the patient support deck has been already extended, this position was locked off and by another locking off the latch by gripping and consequent pushing the handle the patient support deck will be set again into the original standardized length of the patient support deck. Reversely, if the patient support deck is in the original standard length, locking off the rocker arm latch in the telescopically moving connecting member extends the patient support deck by desired length.

This technical innovative solution eliminates components that are necessary for extension of the patient support deck. The said solution is less demanding with respect to production in comparison with the prior arts and is easy and simply manageable. Due to easy way without exerting any big force even less physically effective person may extend the patient support deck alone. The said solution needs less time to finally extend the patient support deck and can be used also in a case when a patient lies on the patient support deck. This said solution presented by us is preferably trouble free as minimum components guarantee minimum failure rate and in addition follows high criteria for hygienic conditions in hospitals, health care and nursing care facilities or settings due to the fact that the extension assembly is design to avoid any leakage into the assembly.

In the preferred embodiment, two telescopically moving connecting members with said locking mechanism are used on the patient support deck. These two telescopically moving connecting members may be controlled by at least one handle or optionally two handles located under the bearing crossbar wherein in this design the handles are preferably interconnected so that one handle can control both telescopically moving connecting members of the patient support deck extension.

In the preferred embodiment, one handle is located under the bearing crossbar of the footboard, also the handle can be located between the bearing crossbar of the footboard and the footboard or preferably the handle can be a part of the footboard crossbar.

In the preferred embodiment, all parts of extension assembly that the telescopically moving connecting member comprises of are produced from metal or alloys for reasons of strength and high load capacity. Optionally the individual components of the extension assembly are produced from other materials such as wood, plastic material or plastic alloys or any other materials that will comply with requirements for strength and high load capacity.

In the preferred embodiment, the telescopically moving connecting member comprises a sliding runner at least on one end of the telescopically moving connecting member which enters the profile of the upper frame of the patient support deck, such sliding runner is preferably made of plastic material, optionally also from other material which causes sufficiently sliding and silent movement outside the profile of the upper frame of the patient support deck. In the preferred embodiment, the rocker arm latch, which is preferably included in the telescopically moving connecting member, comprises a dampening member which can be made of plastic material, rubber or similar. The dampening member damps uncomfortable or unpleasant noises that the latch may emit when metal hits metal.

In the preferred embodiment, the telescopically moving connecting member comprises inside another dampening member which is a spring located between the edge of the connecting member and the S-member of the handle. This said spring damps bearing of a part of the S-member of the handle when being pushed and touched down onto the rocker arm of the locking mechanism.

In the preferred embodiment, the rocker arm located outside the telescopically moving connecting member is on at least one end of the rocker arm over tensioned with spring that enables locking (or arrestment) of the latch which occurs after releasing the handles into the original position where the spring exerts force on the rocker arm with latch that drives the latch into the lock.

In the preferred embodiment, the patient support deck may be extended after locking off by pulling one handle, or by pulling both handles, or by pulling one handle and the footboard.

In the preferred embodiment, the said extension assembly described above may be located also in the head part of the patient support deck using the headboard.

In the preferred embodiment, the upper frame of the patient support deck and the telescopically moving connecting member have square, or rectangle, or circle, or convex polygon, or conic shape.

### BRIEF DESCRIPTION OF THE DRAWINGS

FIG. 1 is a front view of the footboard of the patient support deck, the bearing crossbar of the footboard and the handle of the locking mechanism for extending the patient support deck.

FIG. 2 is an axonometric view of a part of the patient support apparatus with upper frame and the lower frame of the patient support apparatus, where the lower frame is equipped with castors and the upper frame of the patient support apparatus is coupled to the lower frame of the patient support apparatus using scissor lifting mechanism. The upper frame of the patient support apparatus is shown in the extended position therefore the footboard is moved away from the standard length of the upper frame of the patient support deck. The handles of the locking mechanism of the extension assembly of the patient support deck are shown under the bearing crossbar of the footboard of the patient support.

FIG. 3 is an axonometric view of the foot part of the patient support apparatus with a section view of the extension assembly of the upper frame of the patient support deck also showing the locking mechanism for retaining the desired extension length.

FIG. 4 is a side view of the section of the extension assembly of the patient support deck showing also the handle for handling the extension assembly.

FIG. 5 is a side section view of coupling the handle by help of the S-member.

FIG. 6 is a side section view of the locking mechanism of the extension assembly on the opposite end of the telescopically moving connecting member.

FIG. 7 is a bottom view of the locking mechanism of the extension assembly of the patient support deck including the handle.

FIG. 8 is a side view of the foot part of the upper frame of the patient support apparatus with section view of the extension assembly.

### DETAILED DESCRIPTION OF THE DRAWINGS

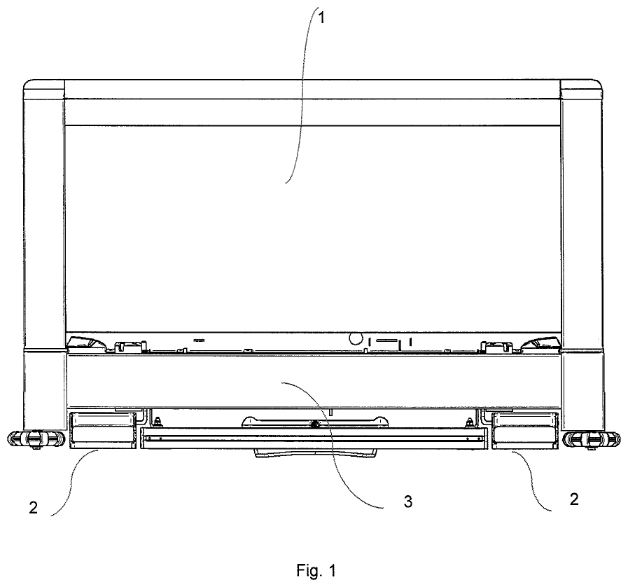

Referring to FIG. 1 a footboard of the patient support apparatus 1 is shown, in another embodiment a headboard of the patient support apparatus can be shown, hereinafter as footboard only. The footboard 1 is coupled to the bearing crossbar 3 of the footboard 1, which is a part of the upper frame 4 of the patient support deck. The handles 2 of the locking and control mechanism of the extension assembly of the upper frame 4 of the patient support deck are shown below the bearing crossbar 3 of the footboard 1. These handles 2 are preferably interconnected together so that mechanism of both arms of the extension assembly of the upper frame 4 of the patient support deck, which is not shown in this figure, could be released or retained. In other embodiment, one handle 2 is located under the bearing crossbar 3 of the footboard 1, which is coupled to both arms of the telescopically moving connecting member 5 of the extension assembly of the upper frame 4 of the patient support deck. In another embodiment, handles 2 are located above the bearing crossbar 3 of the footboard 1 or between the bearing crossbar 3 and the footboard 1 or one handle 2 can be located outside the footboard 1 or the bearing crossbar 3 of the footboard 1. The handles 2 are preferably made from metals and coated by plastic material, or made from plastic material only, metal, or rubber. In the preferred embodiment, one handle 2 for both telescopically moving connecting members 5 of the extension assembly of the upper frame 4 of the patient support deck is located under the bearing crossbar 3 of the footboard 1.

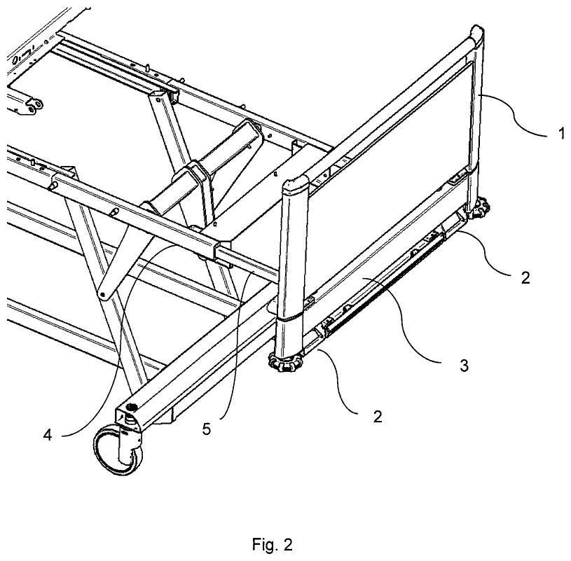

Referring to FIG. 2 a part of the patient support apparatus with upper frame and lower frame is shown. The lower frame comprises a base of the patient support apparatus with castors. Both frames of the patient support apparatus are coupled to scissor lifting mechanism for moving the patient support deck relative to ground. In another embodiment, both frames can be coupled to different mechanism for moving the patient support deck relative to ground (e.g. electric or hydraulic lifting columns etc.). FIG. 2 also shows a part of the upper frame 4 of the patient support deck. The upper frame 4 of the patient support deck comprises two metal profiles running in a parallel way relative to each other, where the telescopically moving connecting member 5 of the extension assembly of the upper frame 4 of the patient support deck enters into these profiles at least on one end of these profiles. The telescopically moving connecting member 5 also comprises two metal profiles running in a parallel way relative to each other but the diameter of these profiles is less than the internal bore of the profiles of the upper frame 4 of the patient support deck to enter in. The telescopically moving connecting member 5 of the extension assembly enters into the upper frame 4 of the patient support deck by one end where the telescopically moving connecting member 5 moves between maximum and minimum extension position. On the other end the telescopically moving connecting member 5 is coupled firmly to the bearing crossbar 3 of the footboard 1, under which the handle or handles 2 for handling and controlling the extension assembly of the upper frame 4 of the patient support deck are located. The telescopically moving connecting member 5 of the extension assembly of the upper frame 4 of the patient support deck moves horizontally and telescopically in the upper frame 4 of the patient support deck from a position fully retracted into the upper frame 4 of the patient support deck to a position fully extended from the upper frame 4 of the patient support deck. The extension assembly, which is not shown in this figure, is inside the telescopically moving connecting member 5 and enables a caregiver to extend the upper frame 4 of the patient support deck by several lengths up to the fully extended position. The maximum extended position of the upper frame 4 of the patient support deck depends direct proportionally on the length of the telescopically moving connecting member 5 and a number of retaining holes 9 for the latch 7 (not shown in this figure), in which the extension assembly is locked. Preferably, the length thus can be extended randomly in different distances depending on the structure of the patient support apparatus and distances of the individual retaining holes 9 (e.g. extension by 15, 20, 30 cm, 50 cm.) The extension of the upper frame 4 of the patient support deck is done by help of the handle or handles 2 located preferably under the bearing crossbar 3 of the footboard 1 by pulling the handle or handles 2 toward a caregiver. The profile of the telescopically moving connecting member 5 is preferably hollow and comprises the extension assembly of the upper frame 4 of the patient support deck (not shown in this figure), which enables releasing of the telescopically moving connecting member 5 and extraction or extension of the telescopically moving connecting member 5 into the desired position as well as consequent retaining of the telescopically moving connecting member 5 in the desired extended position or in the retracted position.

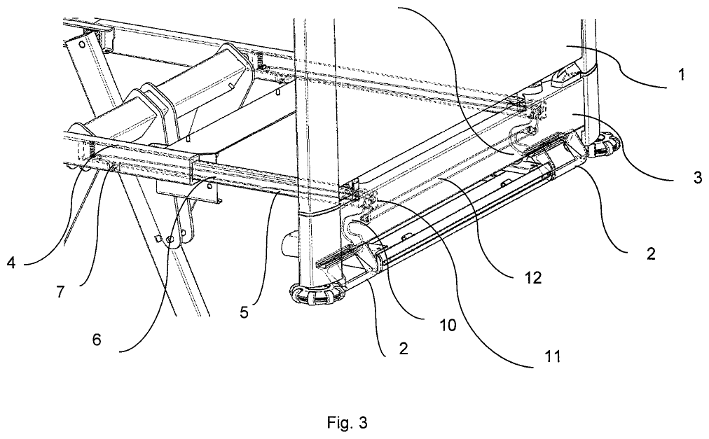

Referring to FIG. 3 a part of the end of the upper frame 4 of the patient support deck and a section view of the telescopically moving connecting member 5 with extension assembly of the upper frame 4 of the patient support deck is shown. In the preferred embodiment, the telescopically moving connecting members 5 are two, one telescopically moving connecting member 5 is on each of the opposite ends of the upper frame 4 of the patient support deck and comprises mechanism inside which enables to extend the patient support deck by the length of the telescopically moving connecting member 5. The telescopically moving connecting member 5 is firmly coupled to the bearing crossbar 3 of the footboard 1 on one end and on the opposite end comprises the sliding runner 16 (not shown in this figure). The sliding runner 16 (not shown in this figure) is designed for sliding movement of the telescopically moving connecting member 5 in the opposite finishing of the profile of the upper frame 4 of the patient support deck. The extension assembly of the patient support deck enables movement of the telescopically moving connecting member 5 between the extended or extracted position and the retracted position. When pulling out the telescopically moving connecting member 5 the upper frame 4 of the patient support deck extends by different lengths. In the contrary, by pushing the telescopically moving connecting member 5 into the profile of the upper frame 4 of the patient support deck the extension of the deck shortens and the patient support apparatus has standard length. Referring to this figure, the telescopically moving connecting member 5 is preferably hollow metal profile comprising at least one rocker arm 6 with the latch 7 on one end. The rocker arm 6 is at least on one end supported by freely inserted flexible member 13, which is free braced between the end of the rocker arm 6 and the internal upper side of the telescopically moving connecting member 5 as shown in the FIG. 3. The telescopically moving connecting member 5 comprises, at least on one end, the retaining hole 9, which the latch 7 of the rocker arm 6 with dampening member 8 of the latch (not shown) goes through. The retaining hole 9 for passing of the latch 7 shaped as the latch 7 is located on the bottom side of the telescopically moving connecting member 5 so that the latch 7 of the rocker arm 6 could pass through the telescopically moving connecting member 5 and could retained the telescopically moving connecting member 5 outside the profile of the upper frame 4 of the patient support deck. In addition, the FIG. 3 shows that the control handle 2 of the extension assembly is coupled to the telescopically moving connecting member 5 by help of S-member 10 which is coupled to the bearing crossbar 3 of the footboard 1 and the telescopically moving connecting member 5 by handle pivot 11. The handle pivot 11 is coupled to the bearing crossbar 3 in the upper S-shaped curving in the place where the telescopically moving connecting member 5 joins the bearing crossbar 3 such that the catch of the S-member 10 could touch down on the opposite side of the rocker arm 6, which is outside the telescopically moving connecting member 5. The rocker arm 6 of the telescopically moving connecting member 5 comprises at least one pivot point which is not shown.

The FIG. 3 also shows that both telescopically moving connecting members 5 of the upper frame 4 of the patient support deck are controlled by handles 2. Both handles 2 are coupled to the telescopically moving connecting members 5 and the extension assemblies by using S-members 10. The FIG. 3 shows that both handles 2 are mutually connected by connecting rod 12, which connects both S-members 10 of both handles 2 so that in case of need movement could be transferred from one handle 2 to another handle 2. Thus controlling force is transmitted from one mechanism to the other one which enables the caregiver to easily control and handle the extension of the patient support deck by one hand and one handle 2. In another embodiment, only one handle 2 can be located under the bearing crossbar 3 of the footboard 1 either in the middle under a part of the bearing crossbar 3 or under the entire bearing crossbar 3 of the footboard 1.

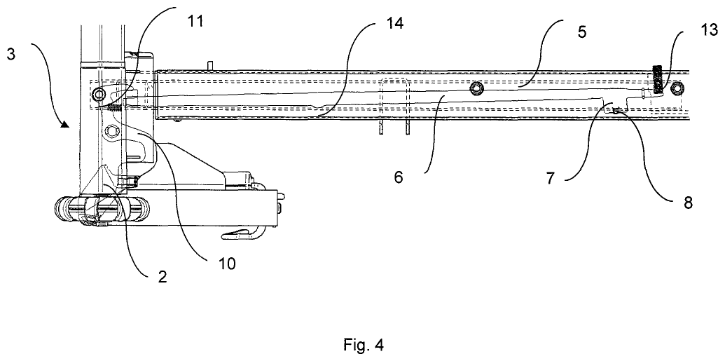

Referring to FIG. 4 a side view of the extension assembly of the patient support deck together with mechanism for controlling by handle 2 is shown. The FIG. 4 shows section view of profile of the telescopically moving connecting member 5, which is in parallel a part by which the patient support apparatus is extended depending on the length of extraction. The telescopically moving connecting member 5 comprises in its internal space the rocker arm 6, which comprises the flexible member 13 of the rocker arm 6 at least on one end. The flexible member 13 comprises a spring which is free inserted between the internal side of the telescopically moving connecting member 5 and the upper surface of the rocker arm 6. The flexible member 13 of the rocker arm 6 creates adherence pressure of the rocker arm 6 to the latch 7. The rocker arm 6 is in contact with S-member 10 at least on one end, which is coupled by handle pivot 11 in the space between the anchoring of the bearing crossbar 3 of the footboard 1 and the telescopically moving connecting member 5. The S-member 10 can be also free hung on the rocker arm 6 as a hook. Preferably, the rocker arm 6 is shaped as a rod with a protrusion on the bottom side, or also the pivot 14 of the rocker arm 6, on which the force is transmitted to the latch 7 that comprises the dampening member 8. By pushing the handle 2 the hook like end of the S-member 10 touches down the rocker arm 6 and thus raises up the latch 7, by which the telescopically moving connecting member 5 is in parallel released from the retained position. Consequently after such release, pulling of the handle 2 toward a caregiver enables the telescopically moving connecting member 5 to move free or sliding outside the profile of the upper frame 4 of the patient support deck, which enables a caregiver to extend then patient support apparatus by needed length. The length of extension is limited by the length of the telescopically moving connecting member 5, which is inside the profile of the upper frame 4 of the patient support deck. The telescopically moving connecting member 5 can extract partially or in its entire length, or cannot be extracted at all. After releasing the latch 7 of the telescopically moving connecting member 5 and pressing the telescopically moving connecting member 5 via the handle 2 the telescopically moving connecting member 5 can be retracted partially or entirely into the original position which is preferably the standard length of the patient support apparatus.

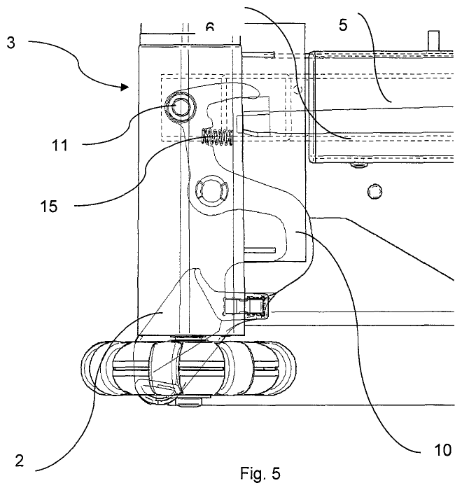

Referring to FIG. 5 a side view of fixation of the handle 2 of the extension assembly of the patient support deck that is located outside of the telescopically moving connecting member 5 is shown. The handle 2 is preferably a part of the S-member 10, which is coupled by handle pivot 11 in the space between the anchoring of the bearing crossbar 3 of the footboard 1 and the telescopically moving connecting member 5. Such location enables the S-member 10, which is S or hook shaped, to hand on to the rocker arm 6 inside the telescopically moving connecting member 5, which enables the handle 2 to control the internal locking mechanism of the telescopically moving connecting member 5. Transmitting the force from S-member 10 of the handle 2 to the rocker arm 6 causes hitting metal to metal thus creating noise which is eliminated by dampening member 15, which is located between the internal side of the S-member 10 and the edge of the telescopically moving connecting member 5. In other embodiments, the dampening member 15 can be a spring or flexible rubber member or can be located in the form of rubber on the hook of the S-member 10.

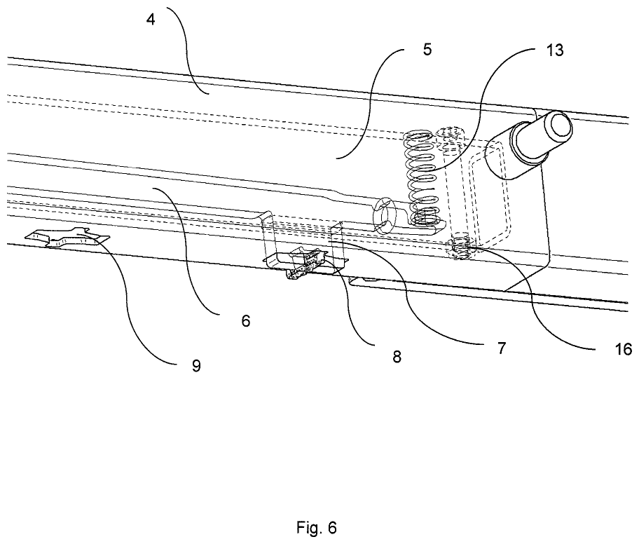

Referring to FIG. 6 an opposite side section view of the locking mechanism of the extension assembly of the upper frame 4 of the patient support deck is shown. The telescopically moving connecting member 5 is located in the profile of the upper frame 4 of the patient support deck, which comprises the sliding runner 16 on at least one end. The sliding runner 16 causes easy and smooth movement of the telescopically moving connecting member 5 in the profile of the upper frame 4 of the patient support deck after releasing of the latch 7 of the rocker arm 6, which is together with the rocker arm 6 outside the telescopically moving connecting member 5. The FIG. 6 shows that the retaining hole 9 shaped as the latch 7 of the rocker arm 6 is not only in the bottom side of the telescopically moving connecting member 5, but also on the bottom side of the profile of the upper frame 4 of the patient support deck. This retaining hole 9 retains extended position of the telescopically moving connecting member. The latch 7 is a part of at least one end of the rocker arm 6, which is a part of the telescopically moving connecting member 5. The rocker arm 6 is preferably free inserted into the internal profile of the telescopically moving connecting member 5, where the flexible member 13 of the rocker arm 6 is located vertically free between the end of the rocker arm 6 and the upper side of the telescopically moving connecting member 5, which creates adherence pressure on the latch 7 of the rocker arm 6. Preferably, the latch 7 of the rocker arm 6 comprises the dampening member 8 on the bottom side of the latch 7 where the edge for falling into the retaining hole 9 of the latch 7. The dampening member 8 of the 7 is made from plastic material or rubber, which dampens any appropriate friction areas or surfaces of the mechanism. In another embodiment, the mechanism of the latch 7 can be organized sidewise or upside down. The latch 7 has a shape of cross, but preferably can have square, or rectangle, or circle, or round, or star shape. The dampening member 8 copies all the above said possible shapes of the latch 7.

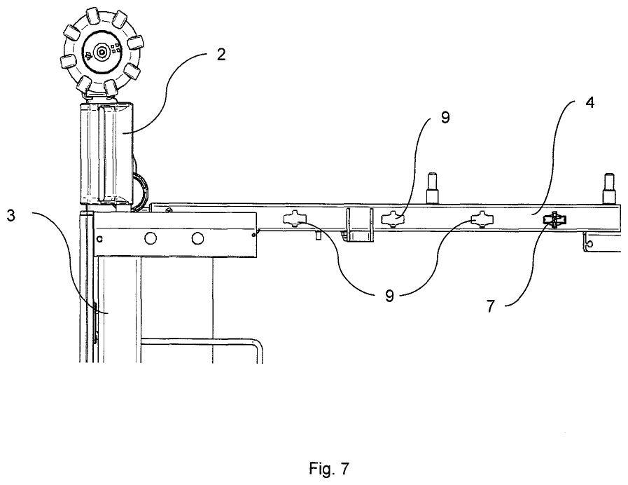

Referring to FIG. 7 a bottom view of the part of the upper frame 4 of the patient support deck with a part of locking mechanism of the extension assembly is shown. The FIG. 7 also shows part of the bearing crossbar 3 of the footboard 1 together with one handle 2, which releases and extends the patient support deck, preferably the handles 2 are two. The bottom view shows that the upper frame 4 of the patient support deck has perforated holes on the bottom side of the profile, which serves as retaining holes 9 for the latch 7. The FIG. 7 obviously shows that at least one latch 7 goes through the retaining hole 9 for retaining of the telescopically moving connecting member 5 which extends the upper frame 4 of the patient support deck. The FIG. 7 shows the telescopically moving connecting member 5 fully retracted into the upper frame 4 of the patient support deck, it means that the extension of the patient support deck is in the retracted position and the patient support apparatus ha standard length given by the manufacturer. The upper frame 4 of the patient support deck has preferably four retaining holes 9 for the latch 7, however in another embodiment a random number of retaining holes can be on the upper frame 4 of the patient support deck depending by which length the patient support apparatus needs to be extended. The FIG. 7 shows three retaining holes 9 according to which the upper frame 4 of the patient support deck can be extended depending in which retaining hole 9 of the latch 7 the extension assembly will be retained. The shown fourth retaining hole serves as a retaining hole 9 for the entire extension assembly.

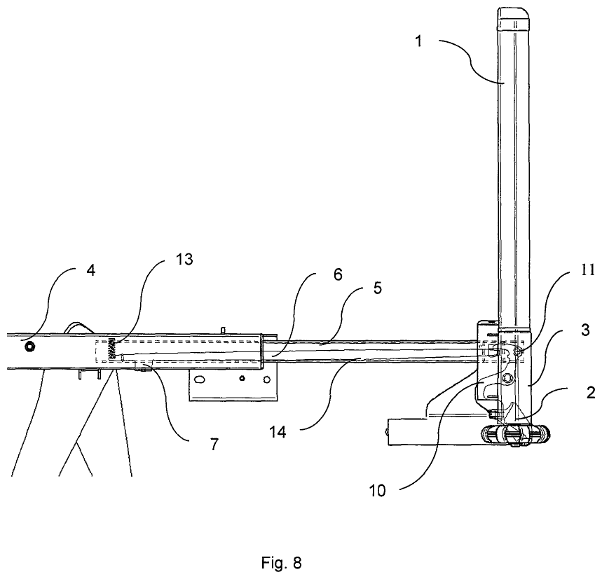

Referring to FIG. 8 a side view of the upper frame 4 of the patient support deck in the extended position is shown, also showing extension assembly of the upper frame 4 of the patient support deck. The telescopically moving connecting member 5 enters the upper frame 4 of the patient support deck and thus extends the patient support apparatus by desired length. The extension assembly comprises the telescopically moving connecting member 5, which is coupled to the bearing crossbar 3 of the footboard 1. The telescopically moving connecting member 5 is a hollow profile comprising the rocker arm 6 which has at least one pivot 14. The pivot 14 is preferably located proportionally in the given point so that the latch 7 can be raised as the latch 7 secures the position of the extension assembly of the patient support apparatus. The pivot 14 of the rocker arm 6 is preferably a protrusion on the rocker arm 6, in other embodiments it can be a pin located proportionally between the rocker arm 6 and the telescopically moving connecting member 5. The pivot 14 of the rocker arm 6 is roughly in one third of the rocker arm 6 between the latch 7 and the control mechanism of the handle 2. The upper frame 4 of the patient support deck has a hole which the telescopically moving connecting member 5 enters into.

It is to be appreciated that the terms “include”, “includes”, and “including” have the same meaning as the terms “comprise”, “comprises”, and “comprising”.

Several embodiments have been discussed in the descriptions. The embodiments discussed herein are not intended to be exhaustive. The terminology which has been used is intended to be in the nature of words of description rather than limitations.

### LIST OF REFERENCE SIGNS

1 footboard (of the patient support apparatus)

2 handle/handles

3 bearing crossbar (of the footboard of the patient support apparatus)

4 upper frame (of the patient support deck)

5 telescopically moving connecting member (extension part)

6 rocker arm

7 latch (of the rocker arm)

8 dampening member (of the latch)

9 retaining hole (for the latch)

10 S-member

11 handle pivot

12 connecting rod (connecting both control members)

13 flexible member (of the rocker arm)

14 pivot (of the rocker arm)

15 dampening member of S-member (spring)

16 sliding runner

1. An extension assembly of an upper frame of a patient support deck comprising
a guiding profile of the upper frame of the patient support deck arranged on at least one end of the upper frame of the patient support deck to be coupled to the extension assembly,
a telescopically moving connecting member firmly coupled to a bearing crossbar of a footboard under which a handle for controlling the extension assembly is located and where the telescopically moving connecting member slides into the guiding profile of the upper frame of the patient support deck, wherein the telescopically moving connecting member comprises a rocker arm in a hollow part of the telescopically moving connecting member, wherein the rocker arm comprises a latch on at least one end of the rocker arm which passes through at least one retaining hole of the latch, wherein the at least one retaining hole of the latch is located in the guiding profile of the upper frame of the patient support deck, the rocker arm further comprising at least one pivot, wherein the rocker arm turns over the pivot, wherein the handle is hung on an opposing end of the rocker arm, wherein the handle controls the entire extension assembly of the upper frame of the patient support deck.

2. The extension assembly of the upper frame of the patient support deck according to claim 1, wherein the guiding profile of the upper frame (4) of the patient support deck comprises the at least one retaining holes of the latch.

3. The extension assembly of the upper frame of the patient support deck according to claim 1, wherein the telescopically moving connecting member is located in the guiding profile of the upper frame of the patient support deck and moves telescopically horizontally in the guiding profile of the upper frame of the patient support deck.

4. The extension assembly of the upper frame of the patient support deck according to claim 1, wherein the telescopically moving connecting member comprises the at least one retaining hole for the latch.

5. The extension assembly of the upper frame of the patient support deck according to claim 1, wherein the telescopically moving connecting member extends the upper frame of the patient support deck.

6. The extension assembly of the upper frame of the patient support deck according to claim 1, wherein the telescopically moving connecting member comprises the rocker arm with the pivot and the latch at least on one side of the rocker arm, wherein the telescopically moving connecting member or the rocker arm comprises at least on one side the handle for controlling the extension assembly.

7. The extension assembly of the upper frame of the patient support deck according to claim 1, wherein the guiding profile of the upper frame of the patient support deck and the telescopically moving connecting member have square, or rectangle, or circle, or convex polygon, or conic shape.

8. The extension assembly of the upper frame of the patient support deck according to claim 1, wherein the handle is coupled to the rocker arm.

9. The extension assembly of the upper frame of the patient support deck according to claim 6, wherein coupling of the handle has shape of S-member.
